(19) United States
(12) Patent Application Publication
(10) Pub. No.: US 2017/0070646 A1
(43) Pub. Date: Mar. 9, 2017

(54) IMAGE FORMING APPARATUS, METHOD FOR DETERMINING PERMISSION/DENIAL OF APPLICATION EXECUTION, AND COMPUTER-READABLE STORAGE MEDIUM FOR COMPUTER PROGRAM

(71) Applicant: Konica Minolta, Inc., Tokyo (JP)

(72) Inventor: Minako Kobayashi, Osaka (JP)

(73) Assignee: Konica Minolta, Inc., Tokyo (JP)

(21) Appl. No.: 15/251,587

(22) Filed: Aug. 30, 2016

(30) Foreign Application Priority Data
Sep. 3, 2015 (JP) 2015-173566

(51) Int. Cl. H04N 1/44; H04N 1/00

(52) U.S. Cl. CPC H04N 1/4433; H04N 1/00854; H04N 1/00244; H04N 1/00129; H04N 1/00925; H04N 1/00938; H04N 2201/0094

(57) ABSTRACT

An image forming apparatus having an API in which a plurality of API functions is prepared is provided. The apparatus includes a determination portion configured to, when a condition necessary to use, among the API functions, an API function contained in an application to be executed in the image forming apparatus is not satisfied at this point in time, request a user to input in order to satisfy the condition, and configured to determine that the condition is satisfied when the input is correctly made and to determine that the condition is not satisfied when the input is not correctly made; and a permission portion configured to give a permission to use the API function contained in the application when the determination portion determines that the condition is satisfied.

This application is based on Japanese patent application No. 2015-173566 filed on Sep. 3, 2015, the contents of which are hereby incorporated by reference.

### BACKGROUND OF THE INVENTION

1. Field of the Invention

The present invention relates to a technology for managing applications which use an API.

2. Description of the Related Art

Image forming apparatuses into which functions such as copying, scanning, faxing, and a document server function are incorporated have attained widespread use. Such an image forming apparatus is sometimes called a “multifunction device” or a “Multi-Functional Peripheral (MFP)”.

Such an image forming apparatus has recently been provided with a web browser. A user accesses a web server via the web browser to cause the web server to execute a web application. This enables the user to be given a variety of services.

There has been proposed a technology for providing a web server called “Internal Web Server” (IWS) in an image forming apparatus. Users or corporations other than a manufacturer of the image forming apparatus create a web application in a language such as a well-known Hypertext Markup Language (HTML) or JavaScript (registered trademark) to install the web application into the image forming apparatus, so that the IWS executes the web application. It is also possible to incorporate API functions for an Application Program Interface (API) of the image forming apparatus. Thus, the IWS improves the scalability of the image forming apparatus more easily than is conventionally possible.

Further, the following technologies have been proposed as a technology for improving the security of devices such as image forming apparatuses. According to one of the technologies, the information processing device is provided with: an information storage means which stores information; a request-receiving means which receives prescribed requests to the information; a setting means which sets whether to permit the prescribed requests for each information; a setting storage means which stores the setting; a determination means which reads out the setting related to the information corresponding to the received requests and determines whether to permit the prescribed requests; and a processing execution means which applies processing corresponding to the prescribed requests to the information when the prescribed requests are permitted (English abstract of Japanese Laid-open Patent Publication No. 2009-80699).

According to the other technology, in a system including a first image processor and a second image processor, the first image processor includes first determination means for determining an operation mode of the first image processor so as to satisfy a prescribed security reference, and export means for exporting a file including information related to the security reference; and the second image processor includes import means for importing the file exported by the first image processor, and second determination means for determining an operation mode of the second image processor so as to satisfy the security reference indicated by the information included in the imported file (English abstract of Japanese Laid-open Patent Publication No. 2014-211771).

As described above, the IWS improves the scalability of the image forming apparatus. However, opening the API unconditionally does not ensure the security as defined in the policy of the image forming apparatus.

To address this, a developer of an application running in the IWS, for example, a third party or an end user, may be obliged to comply with the security policy. This, however, puts a burden on the developer. In addition, the policy is not always followed.

In view of this, the manufacturer of the image forming apparatus has to examine the application running in the IWS, which places a burden on the manufacturer.

### SUMMARY

The present invention has been achieved in light of such an issue, and an object thereof is to execute an application which uses an API of an image forming apparatus with a policy of the image forming apparatus followed without placing a burden of examination on a manufacturer of the image forming apparatus.

An image forming apparatus according to one aspect of the present invention is an image forming apparatus provided with an API in which a plurality of API functions is prepared. The apparatus includes a determination portion configured to, when a condition necessary to use, among the API functions, an API function contained in an application to be executed in the image forming apparatus is not satisfied at this point in time, request a user to input in order to satisfy the condition, and configured to determine that the condition is satisfied when the input is correctly made and to determine that the condition is not satisfied when the input is not correctly made; and a permission portion configured to give a permission to use the API function contained in the application when the determination portion determines that the condition is satisfied.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of the overall configuration of an application system.

FIG. 2 is a diagram showing an example of the hardware configuration of an image forming apparatus.

FIG. 3 is a diagram showing an example of a platform of an image forming apparatus.

FIG. 4 is a diagram showing an example of a native menu screen.

FIG. 5 is a diagram showing an example of an IWS menu screen.

FIG. 6 is a diagram showing an example of categories and types of user accounts.

FIG. 7 is a diagram showing an example of the functional configuration of an MFP system implemented by a security tool.

FIG. 8 is a diagram showing an example of authority data.

FIG. 9 is a diagram showing an example of an entry screen.

FIG. 10 is a sequence diagram depicting an example of the flow of processing performed by a web server system and an MFP system in coordination.

FIG. 11 is a flowchart depicting an example of the flow of execution permission/denial determination processing.

FIG. 12 is a flowchart depicting an example of the flow of processing to determine whether or not to permit execution of a user network setting application.

### DESCRIPTION OF THE PREFERRED EMBODIMENTS

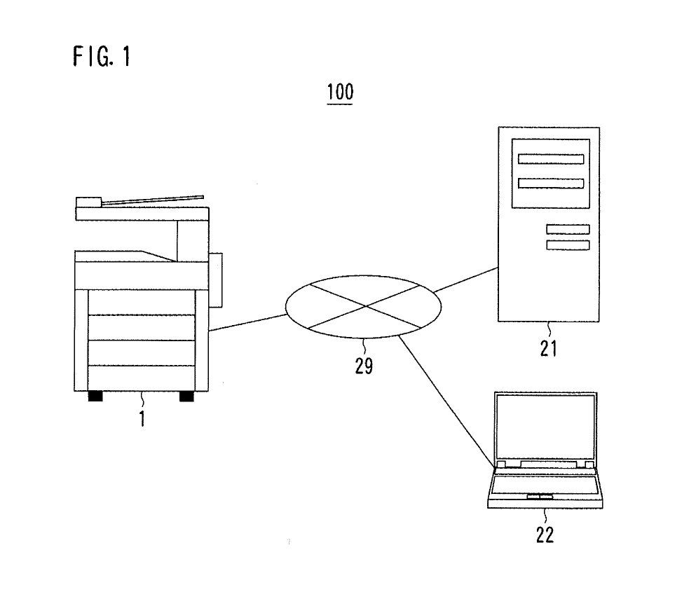

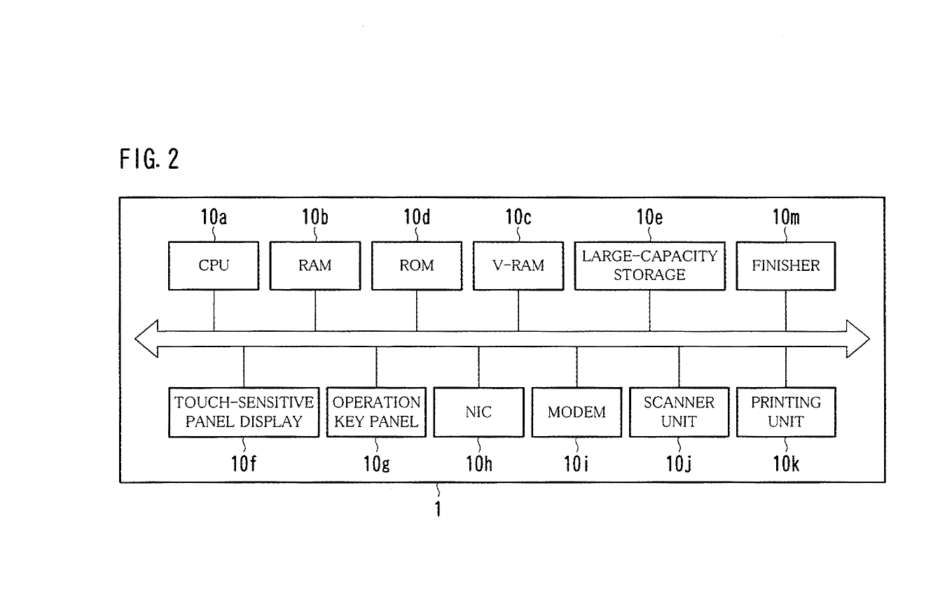

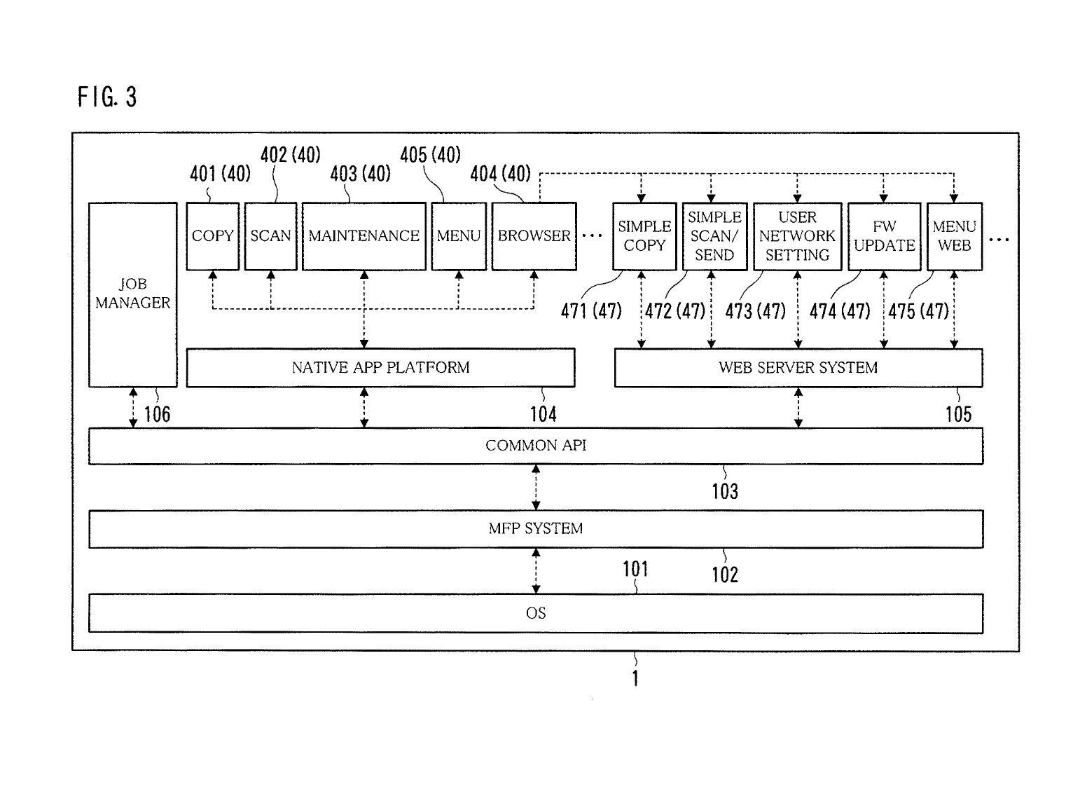

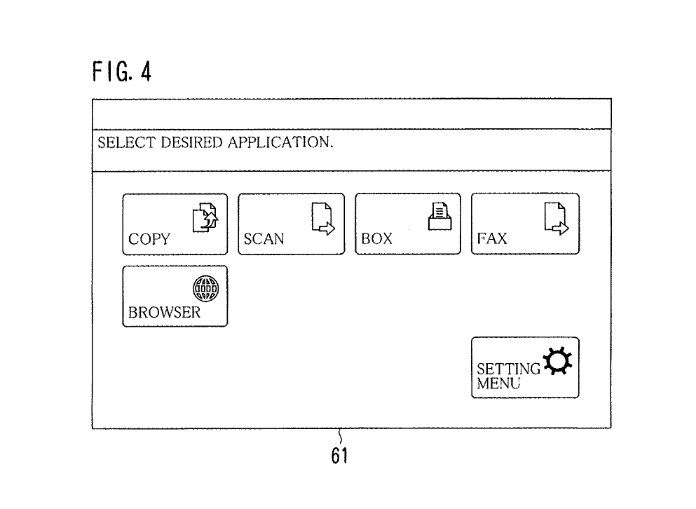

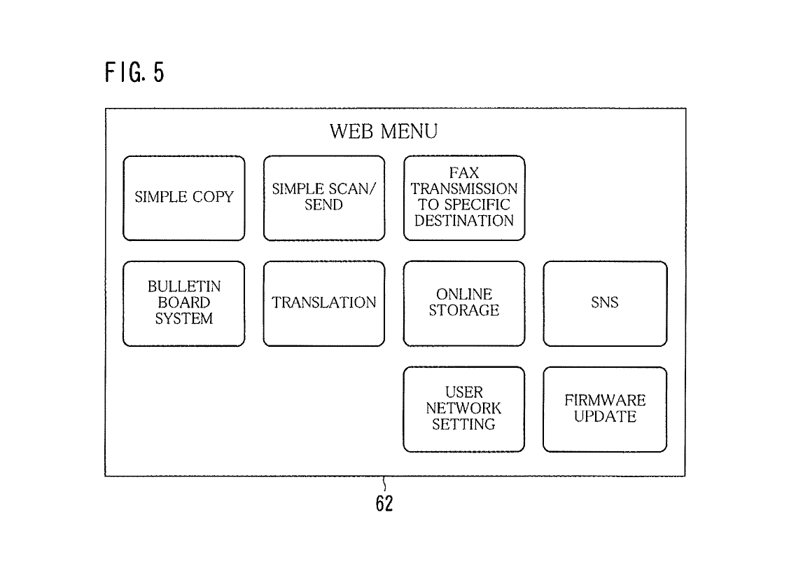

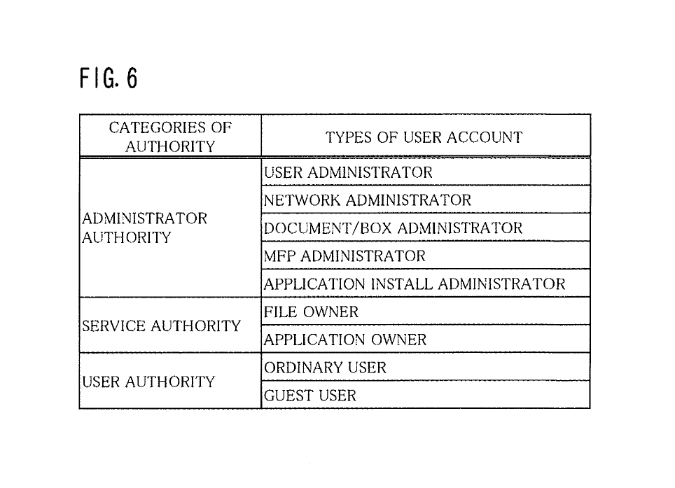

FIG. 1 is a diagram showing an example of the overall configuration of an application system 100. FIG. 2 is a diagram showing an example of the hardware configuration of an image forming apparatus 1. FIG. 3 is a diagram showing an example of a platform of the image forming apparatus 1. FIG. 4 is a diagram showing an example of a native menu screen 61. FIG. 5 is a diagram showing an example of an IWS menu screen 62. FIG. 6 is a diagram showing an example of categories and types of user accounts.

Referring to FIG. 1, the application system 100 is configured of the image forming apparatus 1, a server machine 21, a terminal 22, a communication line 29, and so on.

The image forming apparatus 1 is configured to perform communication with, for example, the server machine 21 and the terminal 22 via the communication line 29. Examples of the communication line 29 are a Local Area Network (LAN), the Internet, a public line, and a dedicated line.

The image forming apparatus is an image processing apparatus into which functions to provide copying service, PC printing service, faxing service, scanning service, and box service are consolidated. The image forming apparatus 1 is usually called a “multifunction device” or a “Multi-Functional Peripheral (MFP)”.

The PC printing service is to print an image onto paper based on image data received from the terminal 22. The PC printing is also called “network printing” or “network print” in some cases.

According to the box service, each user is given a storage area called a “box” or “personal box”, and each user saves image data or the like to his/her storage area and manages the image data therein. The box corresponds to a “folder” or “directory” of a personal computer.

The scanning service is to optically read an image recorded on a sheet of paper to generate image data thereof, and to save the image data to a storage medium or to send the image data to another device.

The server machine 21 is a web server to deliver a web page in response to a request from a web browser.

The terminal 22 is a client which remotely uses the service provided by the image forming apparatus 1. Examples of the terminal 22 are a personal computer, a smartphone, and a tablet computer.

Referring to FIG. 2, the image forming apparatus 1 is configured of a Central Processing Unit (CPU) 10a, Random Access Memory (RAM) 10b, a Video RAM (VRAM) 10c, a Read Only Memory (ROM) 10d, a large-capacity storage 10e, a touch-sensitive panel display 10f, an operation key panel 10g, a Network Interface Card (NIC) 10h, a modem 10i, a scanner unit 10j, a printing unit 10k, a finisher lorn, and so on.

The touch-sensitive panel display 10f displays, for example, a screen for presenting messages to a user, a screen for allowing the user to enter commands or information, a screen for showing results of processing executed by the CPU 10a, and so on. The touch-sensitive panel display 10f sends a signal indicating a touched location to the CPU 10a.

The VRAM 10c is used to store data on a screen to be displayed in the touch-sensitive panel display 10f.

The operation key panel log is a so-called hardware keyboard. The operation key panel log is provided with numeric keys, a start key, a stop key, and a function key.

The NIC 10h performs communication with other devices in accordance with a protocol such as Transmission Control Protocol/Internet Protocol (TCP/IP).

The modem 10i sends and receives image data with a facsimile terminal in accordance with a protocol such as G3.

The scanner unit 10j optically reads an image recorded on a sheet of paper placed on a platen glass to generate image data thereof.

The printing unit 10k prints, onto paper, an image captured by the scanner unit 10j and an image received by the NIC 10h or the modem 10i from other devices.

The finisher 10m staples sheets on which an image has been printed by the printing unit 10k, namely, a printed matter, or punches a hole in the printed matter.

The ROM 10d or the large-capacity storage 10e has installed therein an operating system 101 and an MFP system 102 shown in FIG. 3. Each of the operating system 101 and the MFP system 102 is software used to control overall operation of the image forming apparatus 1, to perform basic processing thereof, or to provide a user interface. The MFP system 102 contains firmware therein.

The ROM 10d or the large-capacity storage 10e is provided with an Application Program Interface (API) 103 in order to easily provide the functionality of the operating system 101 or the MFP system 102 to an application.

In the API 103, there is prepared a multiple of API functions to perform processing by using the functionality of the operating system 101 or the MFP system 102.

The ROM 10d or the large-capacity storage 10e has further installed, therein, a native application platform 104 and a web server system 105.

Each of the native application platform 104 and the web server system 105 performs processing by calling the API functions of the API 103 to use the functionality of the operating system 101 or the MFP system 102.

The native application platform 104 is a platform on which to execute native applications 40.

The native applications 40 are applications specific to the image forming apparatus 1. Basically, the manufacturer of the image forming apparatus 1 installs, in advance, the native applications 40 into the image forming apparatus 1 in a fixed manner.

The web server system 105 is software for an Internal Web Server (IWS). The web server system 105 is a system to execute IWS applications 47.

Each of the IWS applications 47 is configured of, mainly, a source file. Each of the IWS applications 47 sometimes contains an image file or an audio file. Examples of the source file include a web page file and a program file.

The web page file is a file for displaying a web page for the corresponding IWS application 47. The web page file is described in a markup language such as a Hypertext Markup Language (HTML) or an Extensible Markup Language (XML), or, alternatively in a script language such as Python or JavaScript (registered trademark).

The program file is described in a Common Gateway Interface (CGI), for example, in a Web Server Gateway Interface (WSGI) of Python.

In some cases, source files are prepared in one IWS application 47. In other cases, no web page files are prepared in advance and a program file is generated anew when access is made by the web browser.

The source file may be described by using the API functions prepared in the API 103.

As discussed above, the IWS applications 47 can be generated with the use of web technology and the API functions. Accordingly, even a person other than the manufacturer of the image forming apparatus 1, for example, even a third party or an end user, can create the IWS applications 47 more easily than the native applications 40.

The large-capacity storage 10e has installed the native applications 40 therein. The native applications 40 are, for example, a copy application 401, a scanning application 402, a maintenance application 403, a browser application 404, and a menu application 405.

The large-capacity storage 10e also has installed the IWS applications 47 therein. The IWS applications 47 are, for example, a simple copy application 471, a simple scan/send application 472, a user network setting application 473, a firmware update application 474, a menu web application 475, a bulletin board system application, a translation application, and an online storage application.

The copy application 401 and the scanning application 402 are to provide the copy service and the scan service, respectively.

The copy application 401 enables the user to arbitrarily set conditions for almost all items related to copying, for example, conditions for the set of prints, color, paper size, magnification, read resolution, output resolution, print side, N-up printing, and finishing and to cause the image forming apparatus 1 to execute a copy job of scanning an image from a sheet to copy the image onto another sheet.

The scanning application 402 enables the user to arbitrarily set conditions for almost all items related to scanning and to cause the image forming apparatus 1 to execute a scan job of scanning an image from a sheet to generate image data thereof, and of saving or sending the image data.

The maintenance application 403 is to maintain the image forming apparatus 1. To be specific, the maintenance application 403 is to set conditional values of operation of the hardware of the image forming apparatus 1, update the firmware, and update the operating system 101. The maintenance application 403 enables maintenance of almost all items of the image forming apparatus 1.

The browser application 404 is a web browser. As a page called “HOME”, which is a web page to be accessed first after the startup of the image forming apparatus 1, a web page for the menu application 405 described below is set.

The menu application 405 is to display the native menu screen 61 having buttons for the native applications 40 as shown in FIG. 4 and to start one of the native applications 40 corresponding to a button selected by the user.

The simple copy application 471 is to provide the copy service to the user as with the copy application 401. As described above, the copy application 401 enables the user to arbitrarily set conditions for almost all items related to copying. However, the simple copy application 471 enables the user to set conditions only for some specific items related to copying. Since the screen for the simple copy application 471 is simpler than that for the copy application 401, the user can use the simple copy application 471 more easily than the copy application 401.

The simple scan/send application 472 is to provide the scan service to the user as with the scanning application 402. As described above, the scanning application 402 enables the user to arbitrarily set conditions for almost all items related to scanning. However, the simple scan/send application 472 enables the user to set conditions only for some specific items related to scanning. Since the screen for the simple scan/send application 472 is simpler than that for the scanning application 402, the user can use the simple scan/send application 472 more easily than the scanning application 402.

The user network setting application 473 is to make settings for user account and network. To be specific, the settings for user account include adding, deleting, and updating a user account. The settings for network include settings for a host name of the image forming apparatus 1, an IP address of the image forming apparatus 1, an IP address of a Domain Name System (DNS) server, an IP address of a default gateway, and ON/OFF of a TCP/IPv6.

The firmware update application 474 is to update the firmware.

The user may use the maintenance application 403 in order to make settings for user account and network, and to update the firmware. However, each of the user network setting application 473 and the firmware update application 474 is an application specializing in maintaining specific items. The user thus can maintain the image forming apparatus 1 with the use of the user network setting application 473 and the firmware update application 474 more easily than with the use of the maintenance application 403.

The menu web application 475 is to display the IWS menu screen 62 having buttons for the IWS applications 47 as shown in FIG. 5 and to start one of the IWS applications 47 corresponding to a button selected by the user.

In the meantime, the maintenance application 403 can be used only by a user who is given predetermined authority to use the same. The authority required is different for each setting target.

For example, network-related settings can be made only by a user who is given authority of “network administrator”. Updating the firmware can be made only by a user who is given authority of “MFP administrator”. Adding and deleting a user account can be made only by a user who is given authority of “user administrator”. In the image forming apparatus 1, a multiple of types of authority exemplified in FIG. 6 is prepared.

Authority necessary to use the copy application 401, the scanning application 402, and the browser application 404 is settable arbitrarily depending on an environment in which the image forming apparatus 1 is used.

The arbitral settings are, for example, as follows. Both the copy application 401 and the scanning application 402 can be used by anybody, namely, even a user only having a guest account, or, even a user who is not logged into the image forming apparatus 1. The browser application 404 can be used only by a user who has an ordinary user account, namely, a user who has a user account for user authority rather than a guest account.

As with the maintenance application 403, authority necessary for each item is settable in one native application 40. For example, settings can be so made for the copy application 401 that monochrome copy is available even to a user who has only a guest account, and color copy is available only to a user who has an ordinary user account.

The large-capacity storage 10e further has a job manager 106 installed therein. When the user uses any of the native applications 40 and the IWS applications 47 to give a command to execute a job, the job manager 106 registers the job in a queue. The job manager 106 then causes the jobs registered in the que to be executed one by one depending on the situation of each hardware.

Modules and program files constituting the foregoing software pieces are loaded into the RAM 10b as necessary, and are executed by the CPU 10a. Examples of the large-capacity storage 10e are a hard disk drive or a Solid State Drive (SSD).

Meanwhile, as with the case of the native applications 40, a user who has authority suitable for processing to be executed by the IWS applications 47 should be allowed to use the IWS applications 47.

Unfortunately, however, the IWS applications 47 are sometimes created without complying with a policy related to security and the like, which leads to the use by a user who has no authority necessary to use the IWS applications 47. This is not preferable in the light of the security of the image forming apparatus 1.

To address this, the MFP system 102 is provided with a security tool 3. The security tool 3 is used when the web server system 105 executes any one of the IWS applications 47 in order to determine whether or not the user has necessary authority and so on to use that IWS application 47. When determining that the user has necessary authority and so on, the security tool 3 permits execution of that IWS application 47. The mechanism thereof is described below.

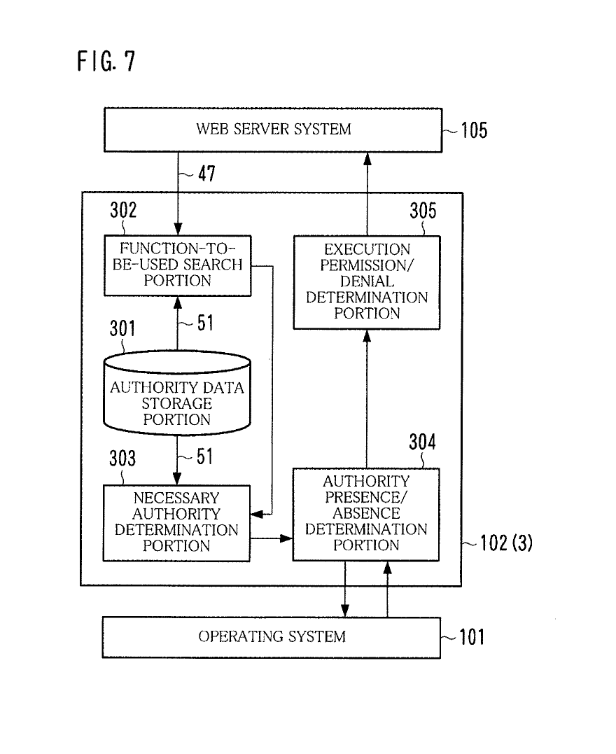

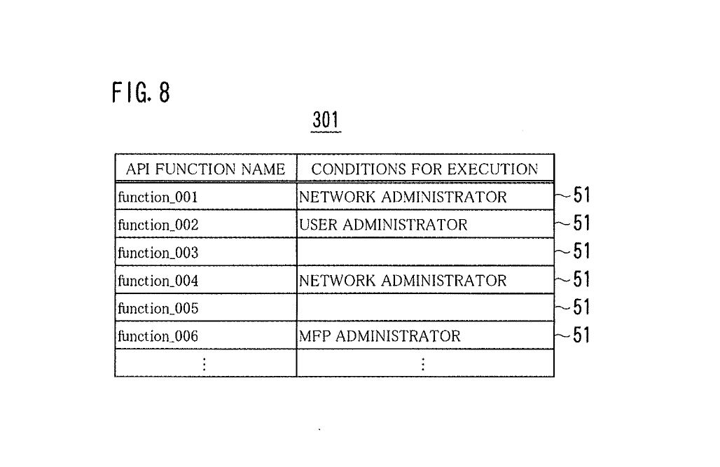

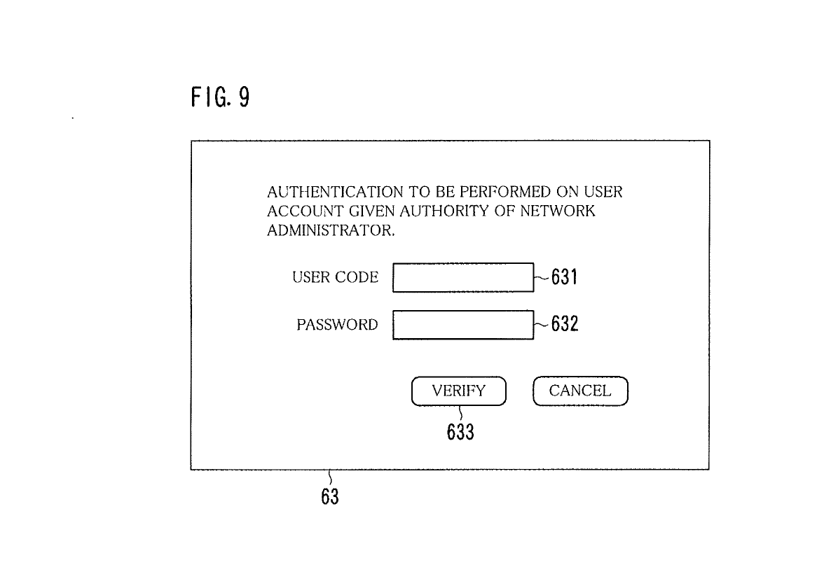

FIG. 7 is a diagram showing an example of the functional configuration of the MFP system 102 implemented by the security tool 3. FIG. 8 is a diagram showing an example of authority data 51. FIG. 9 is a diagram showing an example of an entry screen 63.

The security tool 3 is loaded into the RAM 10b and executed by the CPU 10a. Thereby, an authority data storage portion 301, a function-to-be-used search portion 302, a necessary authority determination portion 303, an authority presence/absence determination portion 304, an execution permission/denial determination portion 305, and so on, all of which are shown in FIG. 7, are implemented.

Referring to FIG. 8, the authority data storage portion 301 stores, for each API function, the authority data 51 indicating a function name and conditions for execution. The •function name” is an identifier to call the corresponding API function. The “conditions for execution” are conditions necessary for execution of the corresponding API function. In this embodiment, particularly, necessary authority is preset as the necessary conditions.

When the web server system 105 attempts to execute one of the IWS applications 47, the function-to-be-used search portion 302 through the execution permission/denial determination portion 305 perform processing for determining whether or not to execute that IWS application 47 as described below.

The function-to-be-used search portion 302 searches for an API function to be used in that IWS application 47 in the following manner. A source file of the IWS application 47 is obtained from the web server system 105. The function-to-be-used search portion 302 searches, in the source file, for a function name indicated in each set of the authority data 51 stored in the authority data storage portion 301. An API function having the function name found out by the search is the API function to be used in the IWS application 47.

The necessary authority determination portion 303 determines authority necessary to execute the API function found by the search by the function-to-be-used search portion 302. To be specific, the necessary authority determination portion 303 determines that authority indicated, as the conditions for execution, in the authority data 51 for the API function is the necessary authority to execute the API function.

The authority presence/absence determination portion 304 determines whether or not the user has the necessary authority determined by the necessary authority determination portion 303 in the following manner.

To be specific, the authority presence/absence determination portion 304 determines whether or not a user who currently logs in the image forming apparatus 1 (hereinafter, such a user referred to as a “logged-in user”) has the necessary authority determined by the necessary authority determination portion 303 by making an inquiry to the operating system 101.

Alternatively, the authority presence/absence determination portion 304 may access a database in which to manage information such as an access right and a type of a user account of each user. The authority presence/absence determination portion 304 then may determine whether or not the logged-in user has the necessary authority based on these pieces of information. Such a database is hereinafter referred to as a •user database”.

If not determining that the logged-in user has the necessary authority, then the authority presence/absence determination portion 304 requests the operating system 101 to verify the logged-in user based on a user account given the necessary authority rather than the user account used by the logged-in user to log into the image forming apparatus 1.

In response to the request, the operating system 101 performs the verification processing in the following manner. The operating system 101 displays, in the touch-sensitive panel display 10f, the entry screen 63 for the logged-in user to enter a user code and a password of the user account given the necessary authority as shown in FIG. 9.

The logged-in user enters the user code and the password into the text boxes 631 and 632 respectively of the entry screen 63. The logged-in user then presses a verify button 633.

In response to the verify button 633 pressed, the operating system 101 checks the authenticity of the user code and the password entered. The operating system 101 further checks whether or not the user account corresponding to the user code is given the necessary authority. The operating system 101 then sends result information on results of the authenticity and the check to the authority presence/absence determination portion 304.

If the result information shows that the authenticity of the user code and the password is checked and that the user account corresponding to the user code is given the necessary authority, then the authority presence/absence determination portion 304 determines that the logged-in user is given the necessary authority. Otherwise, the authority presence/absence determination portion 304 determines that the logged-in user is not given the necessary authority.

When the authority presence/absence determination portion 304 determines that the logged-in user is given the necessary authority, the execution permission/denial determination portion 305 permits execution of the IWS application 47. In contrast, when the authority presence/absence determination portion 304 does not determine that the logged-in user is given the necessary authority, the execution permission/denial determination portion 305 denies the execution of the IWS application 47.

If a plurality of API functions is found out by the search by the function-to-be-used search portion 302, then the necessary authority determination portion 303 determines authority necessary to execute each of the API functions. The authority presence/absence determination portion 304 determines whether or not the logged-in user is given the necessary authority each. When the authority presence/absence determination portion 304 determines that the logged-in user is given all the necessary authority, the execution permission/denial determination portion 305 permits execution of the IWS application 47. When the authority presence/absence determination portion 304 determines that the logged-in user is not given even one of the necessary authority, the execution permission/denial determination portion 305 denies the execution of the IWS application 47.

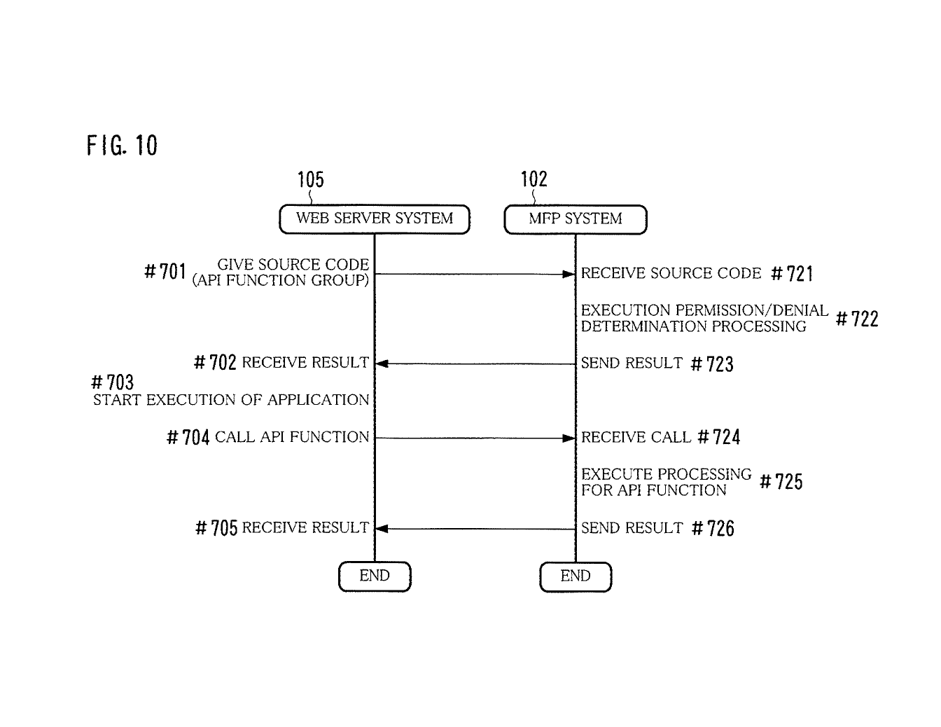

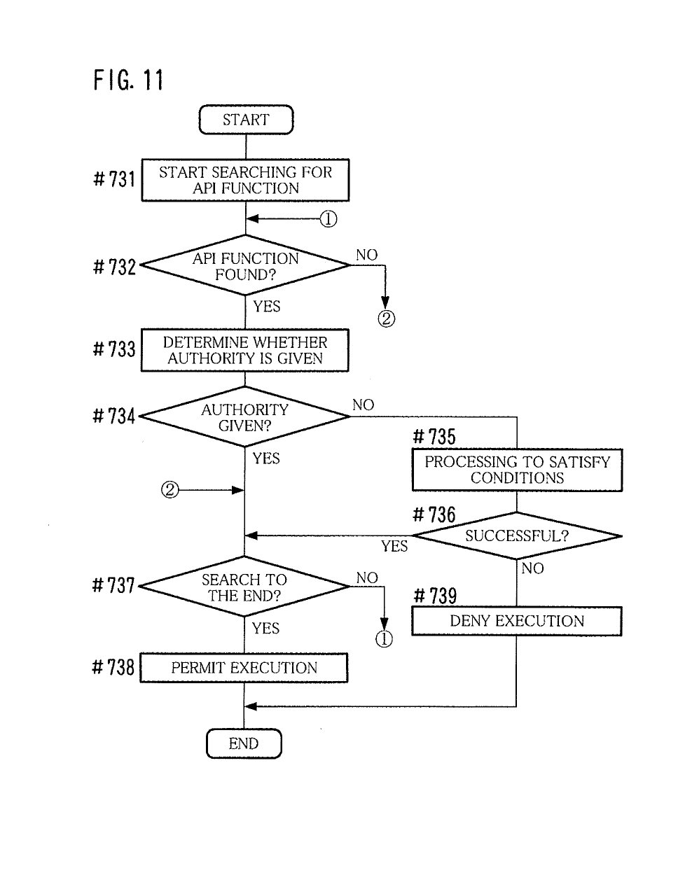

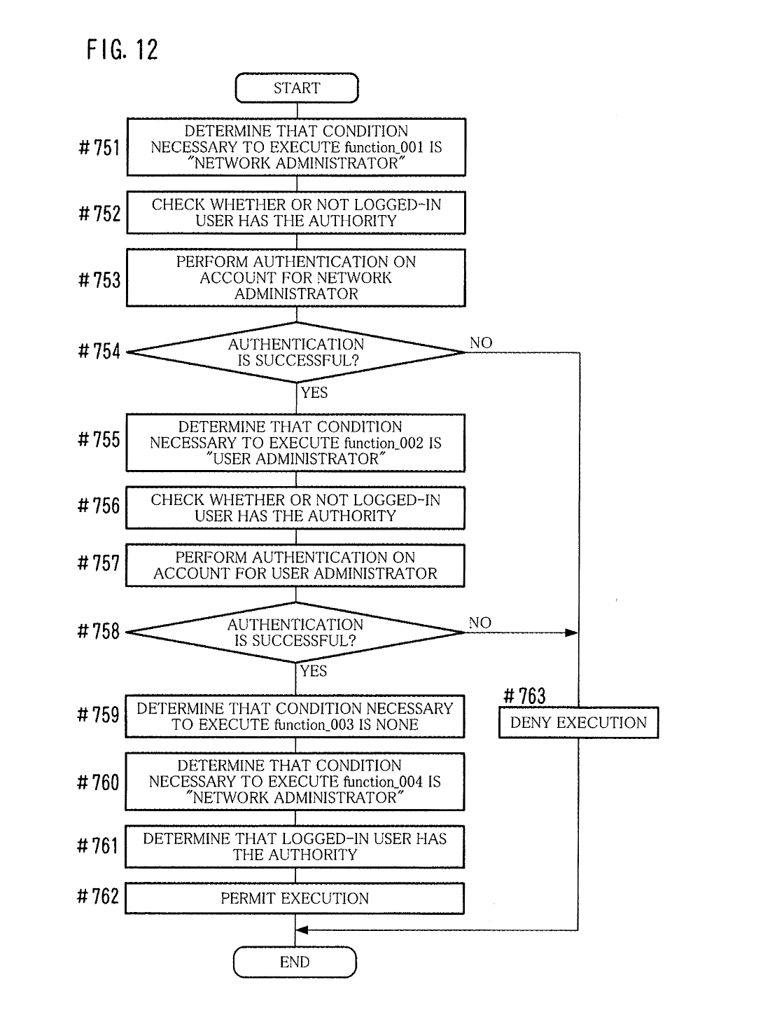

FIG. 10 is a sequence diagram depicting an example of the flow of processing performed by the web server system 105 and the MFP system 102 in coordination. FIG. 11 is a flowchart depicting an example of the flow of execution permission/denial determination processing. FIG. 12 is a flowchart depicting an example of the flow of processing to determine whether or not to permit execution of the user network setting application 473.

The description goes on to the flow of the entire processing performed by the web server system 105 and the MFP system 102 for the case where a command is made to execute the IWS applications 47. The description is provided with reference to FIGS. 10, 11, and 12. Herein, an example is described in which, as the IWS applications 47, particularly, the menu web application 475 and the user network setting application 473 are executed.

The logged-in user presses a button for the browser application 404 in the native menu screen 61 (FIG. 4). In response to the button pressed, the browser application 404 starts in the native application platform 104.

The browser application 404 requests, from the web server system 105, a page called “HOME”, namely, a web page for the menu web application 475.

In response to the request, the web server system 105 and the MFP system 102 perform the processing in the steps depicted in FIG. 10.

The web server system 105 provides the MFP system 102 with a source code of the menu web application 475 (Step #701 of FIG. 10).

When given the source code (Step #721), the MFP system 102 determines, based on the source code, whether or not to execute the IWS application 47 related to the source code, namely, the menu web application 475, by using the security tool 3 as depicted in the steps of FIG. 11 (Step #722).

The MFP system 102 starts searching for an API function in the source code (Step #731 of FIG. 11).

If there is found an API function (YES in Step #732), then the MFP system 102 determines whether or not conditions to execute the API function are satisfied (Step #733). In this embodiment, the MFP system 102 determines, in particular, whether or not the logged-in user is given authority necessary to execute the API function.

If such conditions are not satisfied (NO in Step #734), then the MFP system 102 requests and causes the operating system 101 to execute processing for satisfying the conditions (Step #735).

In this embodiment, in particular, when the user account used for login by the logged-in user has no necessary authority, the MFP system 102 causes the operating system 101 to execute processing for verifying the logged-in user by using another user account having the necessary authority. To be specific, the MFP system 102 causes the operating system 101 to execute processing for displaying the entry screen 63 of FIG. 9, the verification processing, and processing for checking whether or not that another user account has the necessary authority.

When determining that the conditions for executing the API function are satisfied in Step #733 (YES in Step #734), or, alternatively, when the processing for satisfying the conditions in Step #735 is successfully performed (YES in Step #736), the MFP system 102 permits execution of the IWS application 47 related to the source code (Step #738), provided that the search for API function in the source code is finished (YES in Step #737). When the search has not yet been finished NO in Step #737), the processing returns to Step #732 to attempt to search for the remaining API functions. If such remaining API functions are found out (YES in Step #732), then the MFP system 102 performs the processing of Step #733 and onward.

In contrast, when it is not determined (NO in Step #734) that the conditions for the API function are satisfied through the processing in Step #733, and, when the processing in Step #735 is not successfully performed (NO in Step #736), the MFP system 102 denies the execution of the IWS application 47 (Step #739).

In this embodiment, none of API functions used in the menu web application 475 are given necessary authority. Thus, the processing by the security tool 3 is performed, so that the execution of the menu web application 475 is permitted.

Referring back to FIG. 10, the MFP system 102 provides the web server system 105 with the result of determination processing in Step #722 (Step #723).

Upon the receipt of the result (Step #702), the web server system 105 starts executing the IWS application (Step #703) if the result shows permission of the execution. How to execute the IWS application 47 is similar to conventional methods. To be specific, the web server system 105 calls an API function appropriately in accordance with the IWS application 47 (Step #704).

Every time the API function is called (Step #724), the MFP system 102 performs processing for the API function (Step #725), and sends the result of processing to the web server system 105 (Step #726).

The web server system 105 receives the result of processing (Step #705). The web server system 105 uses the result of processing to perform processing based on the IWS application 47. For example, the web server system 105 generates web page data for a web page and send the web page data to the browser application 404.

The IWS application 47 in this example is the menu web application 475. The web server system 105 thus generates web page data on the IWS menu screen 62 (FIG. 5) to send the web page data to the browser application 404.

The browser application 404 displays the IWS menu screen 62. The logged-in user presses a button for the user network setting application 473 in the IWS menu screen 62.

In response to the button pressed, the browser application 404 requests, from the web server system 105, the web page for the user network setting application 473.

The web server system 105 and the MFP system 102 perform the processing as depicted in the steps of FIG. 10, as with the case where the web page for the menu web application 475 is requested.

It is noted, however, that the user network setting application 473 and the menu web application 475 differ from each other in API function to be used. Thus, the result of processing in Step #722 is sometimes different from the case where the web page for the menu web application 475 is requested.

The description goes on to the processing of determining whether or not to permit execution of the user network setting application 473 with reference to FIG. 12.

Meanwhile, four API functions are used in the user network setting application 473. The function names of the four API functions are “function 001”, “function_002”, “function 003”, and “function 004” in order from the top as shown in FIG. 8. Suppose that the logged-in user uses a user account given user authority to log into the image forming apparatus 1.

When finding the first API function (function 001) in the source code of the user network setting application 473, the MFP system 102 determines conditions necessary to execute the API function (Step #751 of FIG. 12). In this embodiment, the MFP system 102 determines, in particular, necessary authority.

Referring to FIG. 8, the authority data 51 for the first API function shows that authority of “network administrator” is required. In view of this, the MFP system 102 determines, in Step #751, that the authority is necessary. The MFP system 102 then checks whether or not the logged-in user has the authority (Step #752).

At this moment, however, the logged-in user has not yet been authenticated based on a user account given the authority of network administrator. The MFP system 102 thus determines, in Step #752, that the logged-in user is not given the authority. The MFP system 102 instructs the operating system 101 to perform the authentication (Step #753).

The operating system 101 displays, as the entry screen 63 (FIG. 9), a screen for the logged-in user to enter a user code and a password for the user account given the authority of network administrator on the touch-sensitive panel display 10f. When the logged-in user enters the user code and the password in the screen, the operating system 101 performs authentication, and further, checks whether or not the user account is given the authority of network administrator. When the authentication is successful and when it is confirmed that the user account is given the authority of network administrator, the operating system 101 sends the result indicative of the foregoing to the MFP system 102.

Upon the receipt of the result (YES in Step #754), the MFP system 102 continues to conduct the search. When finding the second API function (function_002), the MFP system 102 determines conditions necessary to execute the API function (Step #755).

Referring to FIG. 8, the conditions necessary to execute the second API function are that the logged-in user has authority of “user administrator”. In view of this, the MFP system 102 determines, in Step #755, that the authority is necessary. The MFP system 102 then checks whether or not the logged-in user has the authority (Step #756).

At this moment, however, the logged-in user has not yet been authenticated based on a user account given the authority of user administrator. The MFP system 102 thus determines, in Step #756, that the logged-in user is not given the authority. The MFP system 102 instructs the operating system 101 to perform the authentication (Step #757).

The operating system 101 displays, as the entry screen 63, a screen for the logged-in user to enter a user code and a password for the user account given the authority of user administrator on the touch-sensitive panel display 10f. When the logged-in user enters the user code and the password in the screen, the operating system 101 performs authentication, and further, checks whether or not the user account is given the authority of user administrator. When the authentication is successful and when it is confirmed that the user account is given the authority of user administrator, the operating system 101 sends the result indicative of the foregoing to the MFP system 102.

Upon the receipt of the result (YES in Step #758), the MFP system 102 continues to conduct the search. When finding the third API function (function_003), the MFP system 102 determines conditions necessary to execute the API function (Step #759).

Referring to FIG. 8, there are no conditions necessary to execute the third API function. The MFP system 102 therefore determines, in Step #759, that no conditions are required. The MFP system 102 then continues to conduct the search. When finding the fourth API function (function_004), the MFP system 102 determines conditions necessary to execute the API function (Step #760).

Referring to FIG. 8, the conditions necessary to execute the fourth API function are that the logged-in user has authority of “network administrator”. In view of this, the MFP system 102 determines, in Step #760, that the authority is necessary. The MFP system 102 then checks whether or not the logged-in user has the authority (Step #761).

The logged-in user has already been authenticated, in Step #753, based on the user account for network administrator. The MFP system 102 thus determines, in Step #761, that the logged-in user is given the authority.

Searching for API functions in the source code of the user network setting application 473 is finished. The MFP system 102 confirms that the conditions (authority) necessary to each of the API functions are fully satisfied at this point in time. Thus, the MFP system 102 permits execution of the user network setting application 473 (Step #762). If the conditions necessary to execute the API conditions are not satisfied (NO in Step #754, NO in Step #758), then the MFP system 102 prohibits the user network setting application 473 from being executed (Step #763).

According to this embodiment, it is possible to execute an application which uses an API of the image forming apparatus 1 with a policy of the image forming apparatus 1 followed without placing a burden of examination on the manufacturer of the image forming apparatus 1.

In this embodiment, the MFP system 102 searches for an API function in a source code of one of the IWS applications 47. Instead of the MFP system 102, the web server system 105 may conduct the search. In such a case, the web server system 105 may inform the MFP system 102 of the AP function found out by the search. The web server system 105 may make the determination as to whether or not to permit execution of processing based on the API function.

In the meantime, an image forming apparatus is generally so structured that a user code is locked, i.e., the use thereof is prohibited, for a preset period when entry of a password entered along with the user code fails predetermined number of times. When the image forming apparatus 1 applies such a structure, the image forming apparatus 1 may lock the user code of the logged-in user if he/she fails to enter the password in the entry screen 63 of FIG. 9 predetermined number of times.

In this embodiment, the image forming apparatus 1 performs authentication based on a user code and a password. Instead of this, the image forming apparatus 1 may perform biometric authentication based on information on biological traits such as fingerprints. Alternatively, the image forming apparatus 1 may perform Card authentication based on an IC card.

In some cases, the image forming apparatus 1 must restart (reboot) after any of the IWS applications 47 is executed. In other cases, the power supply to the image forming apparatus 1 must be turned OFF and again turned ON after any of the IWS applications 47 is executed. For example, executing the firmware update application 474 updates the firmware, which makes it necessary for the image forming apparatus 1 to restart.

When the image forming apparatus 1 must restart or when the power supply thereto must be turned OFF and again turned ON, the individual portions of the image forming apparatus 1 perform processing preferably in the following manner.

The web server system 105 generates state data indicating different situations at a time when the image forming apparatus 1 must restart or when the power supply thereto must be turned OFF and again turned ON. The web server system 105 stores the state data into a non-volatile storage such as the large-capacity storage 10e. The state data indicates, for example, an identifier (Uniform Resource Locator (URL), for example) of a screen (web page) displayed in the browser application 404, and information on authority given to the logged-in user obtained by the security tool 3. The state data may indicate, when any of the IWS applications 47 is being executed, the position up to which that IWS application 47 has been executed in the source code.

When the image forming apparatus 1 restarts or when the power supply thereto is turned ON, and after the operating system 101 and so on of the image forming apparatus 1 restart completely, the web server system 105 restores, based on the state data, a state at a time when the image forming apparatus 1 must restart or when the power supply thereto must be turned OFF and again turned ON. Thereby, the screen (web page) at that time is reproduced in the browser application 404.

The IWS applications 47 may be created by a third party or an end user. This sometimes causes the user to select, in any of the IWS applications 47 where a plurality of items are set, as set values, values which are prohibited from being combined. In such a case, the operating system 101 or the MFP system 102 detects that the combination of values cannot be set at one time as with conventional methods. The operating system 101 or the MFP system 102 then displays, in the touch-sensitive panel display 10f, a warning window having a message indicating that the combination of values cannot be set at one time through the native application platform 104. Thereby, the warning window appears in a screen (web page) of the browser application 404. At this time, the operating system 101 or the MFP system 102 may prompt the logged-in user to select any of the values, so that only the selected values are set.

While a job is being executed, in some cases, settings cannot be made or the firmware cannot be updated. To address this, the web server system 105 stops executing the user network setting application 473, the menu web application 475, and so on during the execution of the job in the image forming apparatus 1. At this time, a notice screen showing a message informing the stop may be displayed in the touch-sensitive panel display 10f. Upon the completion of the job, the web server system 105 starts or resumes executing the user network setting application 473, the menu web application 475, and so on.

In this embodiment, before the web server system 105 executes an IWS application 47, the MFP system 102 checks whether or not conditions necessary to use (execute) each of API functions contained in a source code of the IWS application 47 are satisfied.

Instead of this, every time an API function is called during execution of the IWS application 47 by the web server system 105, the MFP system 102 may check whether or not conditions necessary to use only the called API function are satisfied. When the conditions are satisfied, the execution of the IWS application 47 continues preferably. When the conditions are not satisfied, the execution of the IWS application 47 are stopped preferably.

Whether to check the permission/denial of the use of the API function in advance, or, during the execution of the IWS application 47 may be set for each of the IWS applications 47.

In this embodiment, the MFP system 102 determines whether or not to permit the use of an API function depending on whether or not a user is given predetermined authority. Instead of this, however, the MFP system 102 may make such a determination depending on whether or not another condition exists, for example, in the following manner.

The image forming apparatus 1 presets, for each logged-in user, the number of sheets available for printing for a predetermined period of time. Hereinafter, such number is referred to as “maximum number of sheets”. In order to use paper number of which exceeds the maximum number of sheets, the logged-in user has to buy a prepaid card with serial number and has to enter the serial number into the image forming apparatus 1.

When finding out an API function related to printing in the source code of the simple copy application 471 (YES in Step #732 of FIG. 11), the MFP system 102 determines, in Step #733, that conditions necessary to use the API function are not satisfied if the number of sheets used for printing for the predetermined period of time by the logged-in user reaches the maximum number of sheets. The MFP system 102 further determines whether or not the number of sheets used for printing this time exceeds the maximum number of sheets based on parameters of the API function. If the determination is positive, then the MFP system 102 determines that conditions necessary to use the API function are not satisfied.

When determining that conditions necessary to use the API function are not satisfied (NO in Step #734), the MFP system 102 displays, instead of the entry screen 63 of FIG. 9, a screen used to enter the serial number in the touch-sensitive panel display 10f. The MFP system 102 also causes the operating system 101 or a billing system to check whether or not the serial number entered by the user is correct (Step #735). If the serial number is correct, and if the number of sheets used for printing this time falls within a range of maximum number of sheets which has been increased by the entry of the serial number (YES in Step #736), then the MFP system 102 determines that conditions necessary to use the API function are satisfied. Alternatively, if the image forming apparatus 1 is provided with a billing device which accepts payment by electronic money or cash, the billing device receives the shortage, the MFP system 102 may determine that conditions necessary to use the API function are satisfied.

In this embodiment, as shown in FIG. 8, a set of authority data 51 is prepared for one API function. However, there are sometimes prepared a plurality of security policies, and any one of the security policies may be selected and applied to the image forming apparatus 1. In view of this, the authority data 51 may be prepared for each policy. The MFP system 102 preferably determines whether or not to permit the use of the API function based on the authority data 51 depending on the policy applied to the image forming apparatus 1.

It is to be understood that the overall configuration of the application system 100 and the image forming apparatus 1, the constituent elements thereof, the content and order of the processing, the structure of data, the configuration of screen, and the like can be appropriately modified without departing from the spirit of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. An image forming apparatus provided with an API in which a plurality of API functions is prepared, the apparatus comprising:
a determination portion configured to, when a condition necessary to use, among the API functions, an API function contained in an application to be executed in the image forming apparatus is not satisfied at this point in time, request a user to input in order to satisfy the condition, and configured to determine that the condition is satisfied when the input is correctly made and to determine that the condition is not satisfied when the input is not correctly made; and
a permission portion configured to give a permission to use the API function contained in the application when the determination portion determines that the condition is satisfied.

2. The image forming apparatus according to claim 1, comprising
a web server configured to execute the application, and
a web browser configured to display a result of the execution of the application by the web server in a display unit.

3. The image forming apparatus according to claim 1, wherein the condition is that a user currently logging into the image forming apparatus is verified based on a user account given authority to use the API function contained in the application.

4. The image forming apparatus according to claim 1, wherein
the condition is that a user currently logging into the image forming apparatus is verified based on a user account given authority to use the API function contained in the application, and
the determination portion requests the user to input, as the input, information on the user account.

5. The image forming apparatus according to claim 1, wherein the determination portion determines whether or not the condition is satisfied before the application is executed.

6. The image forming apparatus according to claim 5, wherein, when the application contains a plurality of API functions, the determination portion determines whether or not the condition is satisfied for each of the API functions.

7. The image forming apparatus according to claim 1, wherein the determination portion determines whether or not the condition is satisfied every time a web server calls the API function contained in the application during execution of the application.

8. A method for determining permission/denial of application execution in an image forming apparatus, the image forming apparatus provided with an API in which a plurality of API functions is prepared, the method comprising:
determining whether or not a condition necessary to use, among the API functions, an API function contained in an application to be executed in the image forming apparatus is satisfied;
requesting a user to input in order to satisfy the condition when the condition necessary to use, among the API functions, the API function contained in the application to be executed in the image forming apparatus is not satisfied at this point in time;
determining that the condition is satisfied when the input is correctly made and determining that the condition is not satisfied when the input is not correctly made; and
giving a permission to use the API function contained in the application when it is determined that the condition is satisfied.

9. A non-transitory computer-readable storage medium storing thereon a computer program used in an image forming apparatus, the image forming apparatus provided with an API in which a plurality of API functions is prepared, the computer program causing the image forming apparatus to perform processing comprising:
request processing of, when a condition necessary to use, among the API functions, an API function contained in an application to be executed in the image forming apparatus is not satisfied at this point in time, requesting a user to input in order to satisfy the condition;
determination processing of determining that the condition is satisfied when the input is correctly made and of determining that the condition is not satisfied when the input is not correctly made; and
permission processing of giving a permission to use the API function contained in the application when it is determined that the condition is satisfied.

10. The non-transitory computer-readable storage medium according to claim 9, wherein
the image forming apparatus includes
a web server configured to execute the application, and
a web browser configured to display a result of the execution of the application by the web server in a display unit.

11. The non-transitory computer-readable storage medium according to claim 9, wherein the condition is that a user currently logging into the image forming apparatus is verified based on a user account given authority to use the API function contained in the application.

12. The non-transitory computer-readable storage medium according to claim 9, wherein
the condition is that a user currently logging into the image forming apparatus is verified based on a user account given authority to use the API function contained in the application, and
the request processing includes requesting the user to input, as the input, information on the user account.

13. The non-transitory computer-readable storage medium according to claim 9, wherein the determination processing is performed before the application is executed.

14. The non-transitory computer-readable storage medium according to claim 9, wherein, when the application contains a plurality of API functions, the determination processing is performed for each of the API functions.

15. The non-transitory computer-readable storage medium according to claim 9, wherein the determination processing is performed every time a web server calls the API function contained in the application during execution of the application.
